(19) United States
(12) Patent Application Publication
(10) Pub. No.: US 2019/0165516 A1
(43) Pub. Date: May 30, 2019

(54) CHARGER AND ELECTRONIC DEVICE

(71) Applicant: Mobvoi Information Technology Co., LTD., Beijing (CN)

(72) Inventors: Jianguo LI, Beijing (CN); Baolin WANG, Beijing (CN)

(73) Assignee: Mobvoi Information Technology Co., LTD., Beijing (CN)

(21) Appl. No.: 15/989,114

(22) Filed: May 24, 2018

(30) Foreign Application Priority Data
Nov. 30, 2017 (CN) 201711239687.4
May 22, 2018 (CN) PCT/CN2018/087898

(51) Int. Cl. H01R 13/64; H01R 33/74; H01R 13/62; H01R 13/631

(52) U.S. Cl. CPC H01R 13/64; H01R 33/74; H01R 13/2471; H01R 13/631; H01R 13/6205

(57) ABSTRACT

The present disclosure relates to the field of electronic devices and provides a charger and an electronic device. The charger includes: a base provided with a holding groove, which is adapted to a back shell of a wearable device and in which a Pogo pin connector is arranged; a first fool-proof structure, which includes a first insert and a second insert. The first insert and the second insert are arranged at the edge of the holding groove. The first insert has a width less than that of the second insert and is used to match with a first locating structure at the side edge of the wearable device. When the charger of the present disclosure charges the wearable device, the fool-proof structure can avoid the misconnection of the positive and negative electrodes in charging and can prevent the Pogo pin connector of the charger from being in direct contact with the Pogo pin connector of the wearable device, which can cause short-circuiting.

### CROSS REFERENCE TO RELATED APPLICATIONS

This application is based upon and claims the benefit of priority of Chinese patent application No. 201711239687.4 filed on Nov. 30, 2017, the contents of which are incorporated herein by reference in its entirety.

### TECHNICAL FIELD

The present disclosure relates to the field of electronic devices, and specifically to a charger and an electronic device.

### BACKGROUND

The existing wearable devices may be charged in various manners. In one manner, a wearable device is equipped with a universal serial bus (USB) interface and is charged through a data wire connected to the USB interface. In another manner, the wearable device is equipped with a wireless induction coil, which cooperates with a wireless induction charging dock for charging the wearable device. In yet another manner, the wearable device is equipped with a Pogo pin connector (a precise connector applied to electronic devices), which cooperates with a Pogo pin charging dock for charging the wearable device.

Nevertheless, in the case of charging with the USB interface, misplug occurs frequently and the USB interface can be damaged. Furthermore, the USB interface provided on the wearable device will reduce the waterproof performance of the wearable device. In the case of charging in the manner of wireless induction, the wearable device has to contain a coil made of copper and the cost of the wearable device will rise. In the case of charging with the Pogo pin connector, misconnect the positive and negative electrodes of the existing Pogo pin connector are usually not differentiated. As such, the user can easily misconnect the positive and negative electrodes, which makes that the wearable device is unable to be charged normally and even the risk of destroying internal circuit of the wearable device exits.

### SUMMARY

The main objective of the present disclosure is to provide a charger and an electronic device, so as to solve the technical problem in which the electronic device is protected by a fool-proof structure when being connected for charging, preventing the positive and negative electrodes from being misconnected during charging.

The objective of the present disclosure and the technical problem to be solved are implemented with the solution described below. The present disclosure provides a charger, which includes: a base, which has a holding groove, the holding groove is adapted to a back shell of a wearable device, a Pogo pin connector is arranged in the holding groove; a first fool-proof structure, which comprises a first insert and a second insert, the first insert and the second insert are arranged at an edge of the holding groove, the first insert has a width less than that of the second insert, the first insert is used to match with a first locating structure at a side edge of the wearable device.

The objective of the present disclosure and the technical problem to be solved may be further implemented in the manners described below.

In one or more embodiments, for the charger described above, the first insert and the second insert are oppositely arranged at two sides at the edge of the holding groove.

In one or more embodiments, for the charger described above, the first fool-proof structure further includes: a locating groove, which is arranged on the surface of the holding groove and is used to match with a bulge structure on the back shell of the wearable device; and/or a locating bulge, which is arranged on the surface of the holding groove and is used to match with a groove structure on the wearable device.

In one or more embodiments, for the charger described above, the locating groove is arranged on a side wall of the holding groove or on a bottom of the holding groove; and/or the locating bulge is arranged on the side wall of the holding groove or on the bottom of the holding groove.

In one or more embodiments, for the charger described above, the first fool-proof structure further includes: at least one first magnet, which is arranged in the base, the first magnet has an S pole, which is directed towards an outer surface of the holding groove and is used to engage with a third magnet on the back shell; and at least one second magnet, which is arrange in the base, the second magnet has an N pole, which is directed towards the outer surface of the holding groove and is used to engage with a fourth magnet on the back shell.

In one or more embodiments, for the charger described above, the at least one first magnet includes multiple first magnets, the first magnets are evenly arranged at positions in the base corresponding to the holding groove.

In one or more embodiments, for the charger described above, the at least one second magnet includes multiple second magnets, the second magnets are evenly arranged at positions in the base corresponding to the holding groove.

The present disclosure provides an electronic device, which includes: a charger, which includes: a base, which has a holding groove, the holding groove is adapted to a back shell of a wearable device, a Pogo pin connector is arranged in the holding groove; and a first fool-proof structure, which comprises a first insert and a second insert, the first insert and the second insert are arranged at an edge of the holding groove, the first insert has a width less than that of the second insert, the first insert is used to match with a first locating structure at a side edge of the wearable device; a wearable device, which includes a first locating structure, the first locating structure is arranged at a side edge of the wearable device and matches with the first insert of the charger.

In one or more embodiments, for the electronic device described above, the first locating structure is an interspace between two function buttons at the side edge of the wearable device.

In one or more embodiments, for the electronic device described above, the wearable device further includes a second fool-proof structure, the second fool-proof structure includes: at least one third magnet, which is arranged on an inner surface of the back shell of the wearable device, the third magnet has an N pole, which faces the inner surface of the back shell and is used to engage with the first magnet of the charger; and at least one fourth magnet, which is arranged on the inner surface of the back shell of the wearable device, the fourth magnet has an S pole, which faces the inner surface of the back shell and is used to engage with the second magnet of the charger.

In one or more embodiments, for the electronic device described above, the at least one third magnet includes multiple third magnets, the third magnets are evenly arranged on the inner surface of the back shell.

In one or more embodiments, for the electronic device described above, the at least one fourth magnet includes multiple fourth magnets, the fourth magnets are evenly arranged on the inner surface of the back shell.

In one or more embodiments, for the electronic device described above, multiple installation grooves are arranged on the inner surface of the back shell, the at least one third magnet and the at least one fourth magnet are respectively arranged in the installation grooves.

In one or more embodiments, for the electronic device described above, the wearable device further includes at least one magnetic flux concentrating cover, the number of the at least one magnetic flux concentrating cover equals to a sum of a number of the at least one third magnet and a number of the at least one fourth magnet, the at least one magnetic flux concentrating cover is respectively arranged on a surface of an S pole of the third magnet and a surface of an N pole of the fourth magnet.

In one or more embodiments, for the electronic device described above, the second fool-proof structure further includes: a bulge structure, which is arranged on an outer surface of the back shell and is used to match with the locating groove of the charger; and/or a groove structure, which is arranged on the outer surface of the back shell and is used to match with the locating bulge of the charger.

In one or more embodiments, for the electronic device describe above, the bulge structure is arranged on at the side edge of the back shell or on the outer surface of the back shell; and/or the groove structure is arranged at the side edge of the back shell or on the outer surface of the back shell.

The charger and the electronic device of the present disclosure have at least advantages described below.

In the present disclosure, the electronic device has the first fool-proof structure. When the charger is connected to the wearable device to charge the wearable device, the Pogo pin connector located in the holding groove of the charger can be connected to the Pogo pin connector of the wearable device for charging the wearable device only when the first fool-proof structure matches with the first locating structure at the side edge of the wearable device. In the related art, the connection to the wearable device has certain drawbacks. For example, in the case of charging with the USB interface, misplug occurs frequently and the USB interface can be damaged. Furthermore, the USB interface provided on the wearable device will reduce the waterproof performance of the wearable device. In the case of charging in the manner of wireless induction, the wearable device has to contain a coil made of copper and the cost of the wearable device will rise. In the case of charging with the Pogo pin connector, misconnect the positive and negative electrodes of the existing Pogo pin connector are usually not differentiated. As such, the user can easily misconnect the positive and negative electrodes, which makes that the wearable device is unable to be charged normally and even the risk of destroying internal circuit of the wearable device exits. In comparison with the related art, the present disclosure provides a charger provided with the first fool-proof structure, which makes that the charger and the wearable device, which are connected for charging, can only be connected in one direction, i.e., the first insert of the first fool-proof structure is inserted into the first locating structure of the wearable device. When the direction is changed, the second insert cannot match with the first locating structure of the wearable device, because the second insert has a width larger than that of the first insert, thus the charger and the wearable device cannot be connected for charging. This ensures that the positive and negative electrodes of the Pogo pin connector of the charger can be correctly connected to the positive and negative electrodes of the Pogo connector of the wearable device when the charger and the wearable device are connected for charging, thereby avoiding the misconnection of the positive and negative electrodes. In addition, when the back shell of the wearable device is made of metal, the first fool-proof structure can prevent the back shell of the wearable device from directly contacting the Pogo pin connector of the charger. In other words, the back shell can be held in the holding groove of the charger only when the first fool-proof structure matches with the first locating structure of the wearable device. This avoids the occurrence of short-circuiting caused by the direct contact between the Pogo pin connector in the holding groove of the charger and the back shell made of metal, and thus ensure the safe use of the charger.

Those described below are merely summary of the present disclosure. In order to provide further understanding of the technical means of the present disclosure and the implementation of the technical means according to the specification, the preferred embodiments of the present disclosure are provided below in detail with reference to the accompanying drawings.

### BRIEF DESCRIPTION OF DRAWINGS

FIG. 1 is a structure diagram of a charger provided by an embodiment of the present disclosure;

FIG. 2 is an exploded diagram of a charger provided by an embodiment of the present disclosure;

FIG. 3 is a structure diagram of an electronic device provided by an embodiment of the present disclosure;

FIG. 4 is a structure diagram of a wearable device provided by an embodiment of the present disclosure;

FIG. 5 is a structure diagram of a back shell of a wearable device provided by an embodiment of the present disclosure;

FIG. 6 is an exploded diagram of a back shell of a wearable device provided by an embodiment of the present disclosure;

FIG. 7 is a structure diagram of a back shell of another wearable device provided by an embodiment of the present disclosure; and

FIG. 8 is an exploded diagram of a back shell of another wearable device provided by an embodiment of the present disclosure.

### DETAILED DESCRIPTION

In order to further explain the technical means of the present disclosure for achieving the desired objective and the effects thereof, the specific implementations, methods, structures, features and effects of the wearable device, the external device and electronic device according to the present disclosure are described hereinafter in detail. In the description below, each “one embodiment” or “an embodiment” refers to a different embodiment or a same embodiment. Furthermore, the specific features, structures, or characteristics in one or more embodiments may be combined with each other in any way.

### Embodiment 1

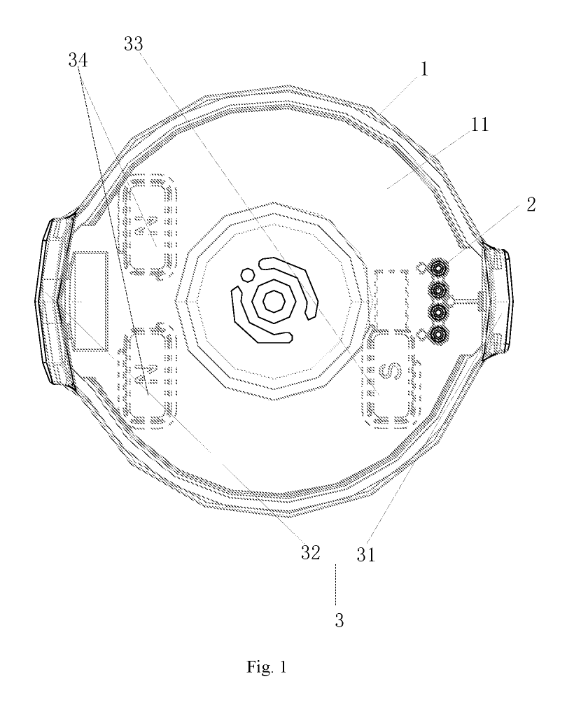

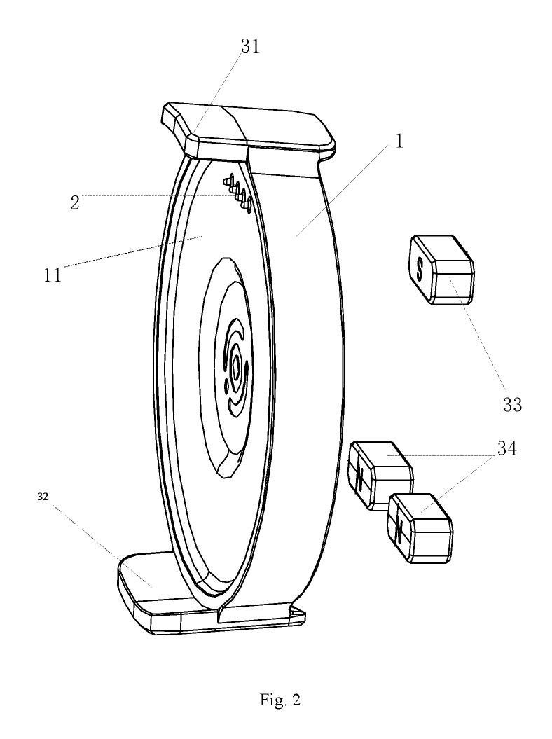

As shown in FIGS. 1 and 2, the embodiment 1 of the present disclosure provides a charger. The charger includes a base 1 and a first fool-proof structure 3. The base 1 has a holding groove 11 adapted to a back shell of a wearable device. A Pogo pin connector 2 is arranged in the holding groove 11. The first fool-proof structure 3 includes a first insert 31 and a second insert 32, which are arranged at an edge of the holding groove 11. The first insert 31 has a width less than that of the second insert 32. The first insert 31 is used to match with a first locating structure of the wearable device.

Specifically, the base has a main function of charging the wearable device. The shape of the holding groove of the base needs to match with the shape of the back shell of the wearable device. The electronic component for implementing the charging function is arranged in the base. The base may further be connected to a connecting wire, which is connected to an electrical outlet. The connecting wire is connected to the Pogo pin connector of the holding groove. The first insert and the second insert of the first fool-proof structure are dimensioned in such a way that the width of the first insert is less than the width of the second insert. Therefore, the first insert may match with the first locating structure of the wearable device, i.e., the first insert may be inserted into the first locating structure. The first locating structure may be an interspace between two buttons at the side edge of the wearable device. For example, the first locating structure may be the interspace between two function buttons at the side edge of a smartwatch. The first insert and the second insert may have a same shape. The first insert may be a block with a rectangular section, or a block with a rectangular section and a radian. The arrangement of the second insert is the same as that of the first insert. The base, the first insert and the second insert may be molded in one body. For example, the base, the first insert and the second insert may be injection molded in one body from plastic.

In the present disclosure, the charger is provided with a first fool-proof structure. When the charger is connected to the wearable device to charge the wearable device, the Pogo pin connector located in the holding groove of the charger can be connected to the Pogo pin connector of the wearable device for charging the wearable device only when the first fool-proof structure matches with the first locating structure at the side edge of the wearable device. In the related art, the connection to the wearable device has certain drawbacks. For example, in the case of charging with the USB interface, misplug occurs frequently and the USB interface can be damaged. Furthermore, the USB interface provided on the wearable device will reduce the waterproof performance of the wearable device. In the case of charging in the manner of wireless induction, the wearable device has to contain a coil made of copper and the cost of the wearable device will rise. In the case of charging with the Pogo pin connector, misconnect the positive and negative electrodes of the existing Pogo pin connector are usually not differentiated. As such, the user can easily misconnect the positive and negative electrodes, which makes that the wearable device is unable to be charged normally and even the risk of destroying internal circuit of the wearable device exits. In comparison with the related art, the present disclosure provides a charger provided with the first fool-proof structure, which makes that the charger and the wearable device, which are connected for charging, can only be connected in one direction, i.e., the first insert of the first fool-proof structure is inserted into the first locating structure of the wearable device. When the direction is changed, the second insert cannot match with the first locating structure of the wearable device, because the second insert has a width larger than that of the first insert, thus the charger and the wearable device cannot be connected for charging. This ensures that the positive and negative electrodes of the Pogo pin connector of the charger can be correctly connected to the positive and negative electrodes of the Pogo connector of the wearable device when the charger and the wearable device are connected for charging, thereby avoiding the misconnection of the positive and negative electrodes. In addition, when the back shell of the wearable device is made of metal, the first fool-proof structure can prevent the back shell of the wearable device from directly contacting the Pogo pin connector of the charger. In other words, the back shell can be held in the holding groove of the charger only when the first fool-proof structure matches with the first locating structure of the wearable device. This avoids the occurrence of short-circuiting caused by the direct contact between the Pogo pin connector in the holding groove of the charger and the back shell made of metal, and thus ensure the safe use of the charger.

As shown in FIGS. 1 and 2, in the specific implementation, the first insert 31 and the second insert 32 are oppositely arranged at two sides at the edge of the holding groove.

Specifically, the first insert and the second insert may be arranged at two side at the edge of the holding groove in a manner of facing each other, or may be arranged at two side at the edge of the holding groove in a manner of being diagonally opposite to each other. In a preferred arrangement, the first insert and the second insert are arranged in the manner of facing each other.

Further, the first fool-proof structure further includes: a locating groove, which is arranged on the surface of the holding groove and is used to match with the bulge structure of the back shell of the wearable device; and/or, a locating bulge, which is arranged on the surface of the holding groove and is used to match with the groove structure of the wearable device.

Specifically, the locating bulge may have any shape, such as a cuboid, a cube, a semi-sphere or a shape of bulging pattern. The locating bulge may be arranged at any position on the surface of the holding groove. For example, the locating bulge may be arranged on the side wall of the holding groove or on the bottom of the holding groove. The locating groove may also have any shape, such as a cuboid, a cube, a semi-sphere or a shape of bulging pattern. A second locating groove may be arranged on the side wall of the holding groove or on the bottom of the holding groove.

In addition, it should be noted that, the number of the locating grooves needs to be the same as the number of the bulge structures on the back shell of the wearable device. The shape of the locating grooves needs to match with the shape of the bulge structures. The distribution of the locating grooves in the holding groove needs to correspond to the distribution of the bulge structures on the back shell. In a similar manner, the number of the locating bulges needs to be the same as the number of the groove structures on the back shell of the wearable device. The shape of the locating bulges needs to match with the shape of the groove structures. The distribution of the locating bulges in the holding groove needs to correspond to the distribution of the groove structures on the back shell.

As shown in FIGS. 1 and 2, in the specific implementation, in order to implement a fool-proof function of the charger in charging, the first fool-proof structure further includes: a first magnet 33 and a second magnet 34. The first magnet 33 is arranged in the base 1. The S pole of the first magnet 33 is directed towards the outer surface of the holding groove 11 and is used to engage with a third magnet on the back shell. The N pole of the second magnet 34 is directed towards the outer surface of the holding groove 11 and is used to engage with a fourth magnet on the back shell.

Specifically, the shape and the size of the first magnet and the second magnet of the first fool-proof structure may be the same as those of the third magnet and the fourth magnet inside the back shell of the wearable device. The position of the first magnet in the holding groove corresponds to the position of the third magnet on the back shell of the wearable device. Similarly, the position of the second magnet in the holding groove corresponds to the position of the fourth magnet on the back shell of the wearable device. Additionally, in one or more embodiments, the Pogo pin connector in the holding groove is arranged at a distance from the first magnet and the second magnet. For example, the first magnet and the second magnet are arranged at respective sides of the Pogo pin connector.

In use, since the first insert matches with the first locating structure at the side edge of the wearable device, the S pole of the first magnet of the first fool-proof structure needs to engage with the N pole of the third magnet in the wearable device and the N pole of the second magnet of the first fool-proof structure needs to engage with the S pole of the fourth magnet in the wearable device. In this way, the Pogo pin connector of the charger can be connected to the Pogo pin connector of the wearable device to charge the wearable device and to further improve the effect of the first fool-proof structure.

In the specific implementation, in order to have a sufficient attraction between the charger and the wearable in charging, so as to ensure the stability during the charging and avoid the unstable connection caused by the inclination of connection or the sway, there are multiple first magnets which are evenly arranged at positions in the holding groove of the base; or, there are multiple second magnets which are evenly arranged at positions in the holding roove of the base. Alternatively, multiple first magnets and multiple second magnets exits.

In addition, it should be noted that, the number of the first magnets may equal to the number of the third magnets on the back shell of the wearable device, and the distribution of the first magnets in the holding groove needs to correspond to the distribution of the third magnets on the back shell. Similarly, the number of the second magnets may equal to the number of the fourth magnets on the back shell of the wearable device, and the distribution of the second magnets in the holding groove needs to correspond to the distribution of the fourth magnets on the back shell.

### Embodiment 2

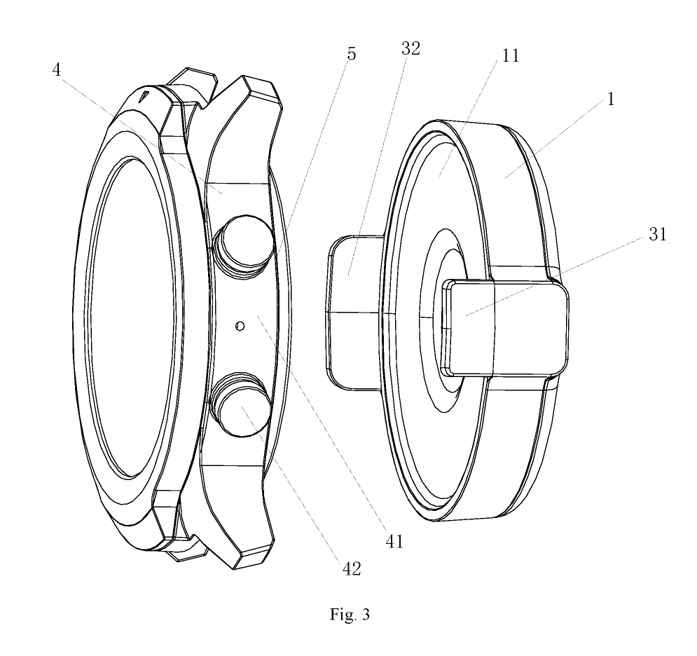

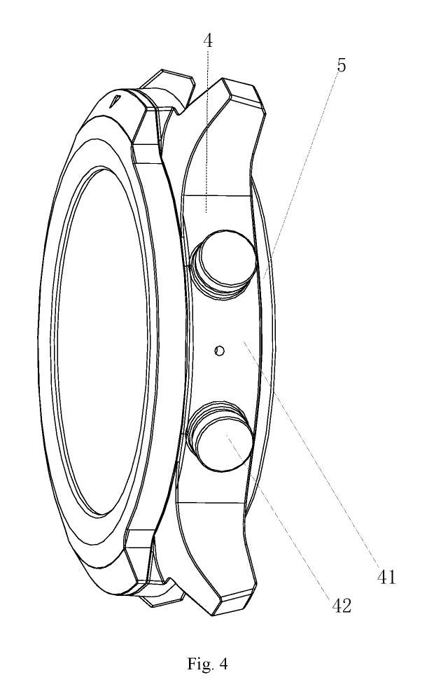

As shown in FIGS. 1 to 4, the embodiment 2 of the present disclosure provides an electronic device. The electronic device includes: a charger and a wearable device 4. The charger includes: a base 1 and a first fool-proof structure 3. The base 1 has a holding groove 11 adapted to a back shell of a wearable device. A Pogo pin connector 2 is arranged in the holding groove 11. The first fool-proof structure 3 includes a first insert 31 and a second insert 32, which are arranged at an edge of the holding groove 11. The first insert 31 has a width less than that of the second insert 32. The first insert 31 is used to match with a first locating structure of the wearable device. A first locating structure 41 is arranged at the side edge of the wearable device 4 and matches with the first insert 31 of the charger.

Specifically, the charger in the embodiment 2 may be the charger provided by embodiment 1 and has an implementation structure as described with reference to embodiment 1, which will not be repeated here. The wearable device of the present disclosure may a smartwatch, a smart bracelet, an electronic sphygmomanometer, a virtual reality (VR) device, an augmented reality (AR) device, etc., and may be worn on wrist, neck, head of a user or before the eyes of the user. The preferred device of the present disclosure is smartwatch. The body of the wearable device is a component containing main electronic devices and is for example the watch head of the smartwatch. The back shell is a shell fastened to the rear surface of the body or on a side surface opposite to the display surface of the wearable device. The structure and shape of the back shell may be designed based on the shape and feature of the wearable device, and may have a circular shape, an ellipse shape, a rectangular shape or any other shape. The back shell may be made of plastic or metal. In addition, the shape of the back shell needs to match with the holding groove of the charger. The first locating structure may be a groove at the side edge of the wearable device of an interspace between two function buttons of the wearable device.

In the embodiment 2 of the present disclosure, in the case where the charger is connected to the wearable device to charge the wearable device, the back shell of the wearable device can be held in the holding groove of the charger only when the first insert of the first fool-proof structure is inserted into the first locating structure of the wearable device. Then, the Pogo pin connector in the holding groove is connected to the Pogo pin connector on the back shell of the wearable device, so as to charge the wearable device. In the case where the first insert is not inserted into the first locating device, the back shell of the wearable device cannot be held in the holding groove, and the wearable device cannot be charged.

In the present disclosure, the charger is provided with a first fool-proof structure. When the charger is connected to the wearable device to charge the wearable device, the Pogo pin connector located in the holding groove of the charger can be connected to the Pogo pin connector of the wearable device for charging the wearable device only when the first fool-proof structure matches with the first locating structure at the side edge of the wearable device. In the related art, the connection to the wearable device has certain drawbacks. For example, in the case of charging with the USB interface, misplug occurs frequently and the USB interface can be damaged. Furthermore, the USB interface provided on the wearable device will reduce the waterproof performance of the wearable device. In the case of charging in the manner of wireless induction, the wearable device has to contain a coil made of copper and the cost of the wearable device will rise. In the case of charging with the Pogo pin connector, misconnect the positive and negative electrodes of the existing Pogo pin connector are usually not differentiated. As such, the user can easily misconnect the positive and negative electrodes, which makes that the wearable device is unable to be charged normally and even the risk of destroying internal circuit of the wearable device exits. In comparison with the related art, the present disclosure provides a charger provided with the first fool-proof structure, which makes that the charger and the wearable device, which are connected for charging, can only be connected in one direction, i.e., the first insert of the first fool-proof structure is inserted into the first locating structure of the wearable device. When the direction is changed, the second insert cannot match with the first locating structure of the wearable device, because the second insert has a width larger than that of the first insert, thus the charger and the wearable device cannot be connected for charging. This ensures that the positive and negative electrodes of the Pogo pin connector of the charger can be correctly connected to the positive and negative electrodes of the Pogo connector of the wearable device when the charger and the wearable device are connected for charging, thereby avoiding the misconnection of the positive and negative electrodes. In addition, when the back shell of the wearable device is made of metal, the first fool-proof structure can prevent the back shell of the wearable device from directly contacting the Pogo pin connector of the charger. In other words, the back shell can be held in the holding groove of the charger only when the first fool-proof structure matches with the first locating structure of the wearable device. This avoids the occurrence of short-circuiting caused by the direct contact between the Pogo pin connector in the holding groove of the charger and the back shell made of metal, and thus ensure the safe use of the charger.

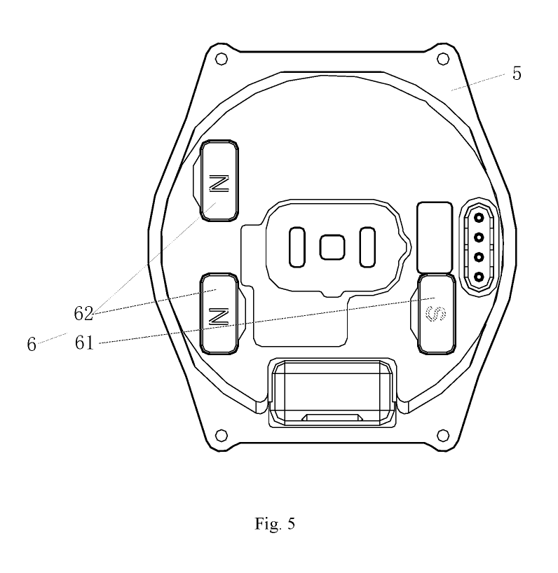

As shown in FIGS. 1, 2, 5 and 6, in the specific implementation, the wearable device may also include a second fool-proof structure 6. The second fool-proof structure 6 includes a third magnet 61 and a fourth magnet 62. The third magnet 61 is arranged on the inner surface of the back shell 5 of the wearable device and has an N pole facing the inner surface of the back shell 5. The fourth magnet 62 is arranged on the inner surface of the back shell 5 and has an S pole facing the inner surface of the back shell 5. The third magnet 61 is used to engage with the first magnet 33 of the charger. The fourth magnet 62 is used to engage with the second magnet 34 of the charger.

Specifically, the third magnet and the fourth magnet are arranged on the inner surface of the back shell. In the course of normally charging the wearable device and normally wearing the wearable device, the third magnet and the fourth magnet will not be abraded. As such, the impact on the life of the magnets of the damage to the surface coating over the third magnet and the fourth magnet caused by abrasion, knocking or scratching is avoided, and the technology difficulty of the surface treatment of the exposed magnets is lowered. At the same time, the arrangement of the second fool-proof structure, which cooperates with the first fool-proof structure, further strengthens the effect of fool-proof. As such, when the charger is connected to the wearable device to charge the wearable device, only in the case where not only the insert matches with the first locating structure, but the first magnet and the second magnet of the first fool-proof structure respectively engage with the third magnet and the fourth magnet of the second fool-proof structure, the back shell of the wearable device can be held in the holding groove of the charger and the Pogo pin connector of the charger can be connected to the Pogo pin connector of the wearable device, so as to charge the wearable device. Otherwise, when the first fool-proof does not match with the first locating structure and the second fool-proof structure of the wearable device, the back shell of the wearable cannot be held in the holding groove and the wearable device cannot be charged.

In the specific implementation, in order to connect the charger to the wearable device to charge the wearable device, an attraction large enough between the charger and the wearable device is required to ensure the stability during charging and to avoid the unstable connection caused by the inclination of connection or the sway. In the present disclosure, there are multiple third magnets which are evenly arranged on the inner surface of the back shell; or, there are multiple fourth magnets which are evenly arranged on the inner surface of the back shell. Alternatively, multiple third magnets and multiple fourth magnets exits.

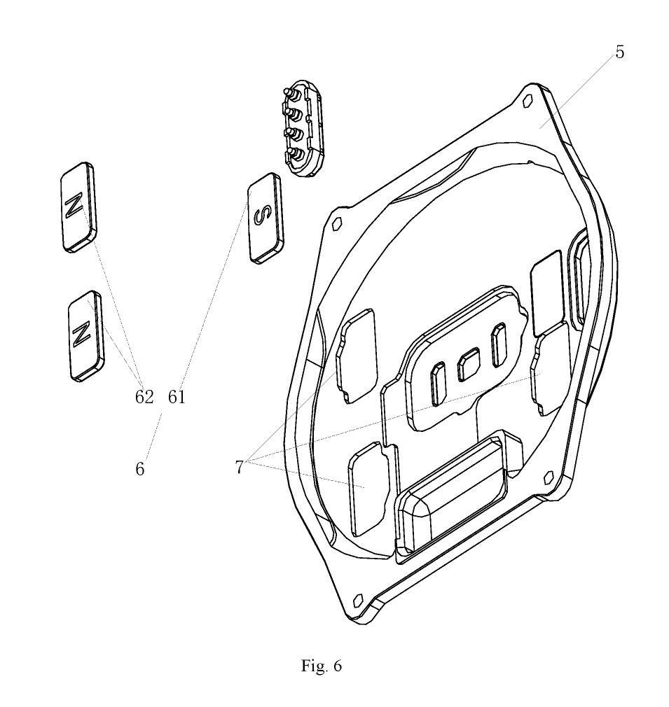

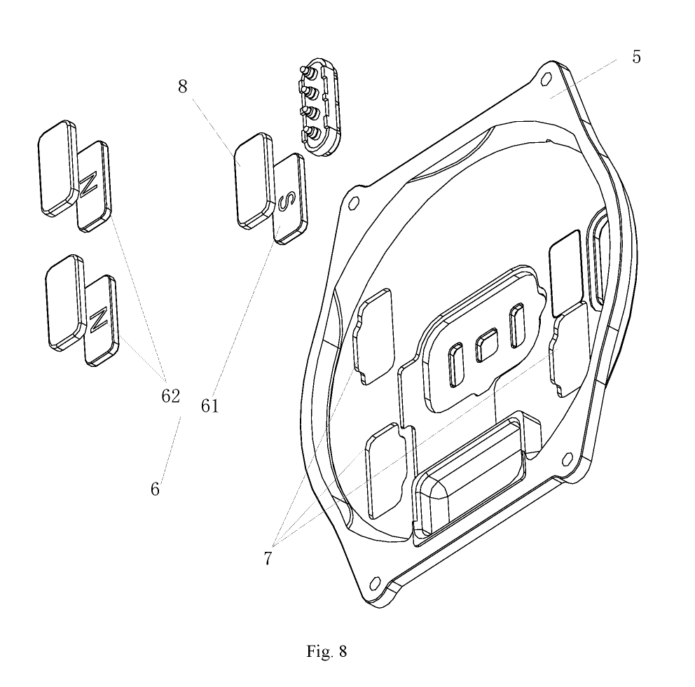

As shown in FIGS. 6 and 8, in the specific implementation, installation grooves 7 are arranged on the inner surface of the back shell 5. The third magnet 61 and the fourth magnet 62 are respectively arranged in the installation grooves 7.

Specifically, the installation grooves arranged on the inner surface of the back shell are shaped according to the shape of the third magnet and the shape of the fourth magnet. The depth of the installation grooves equals to the depth of the third magnet and the fourth magnet. The installation grooves may be formed by concaving the inner surface of the back shell towards the outer surface of the back shell, or may be formed by arranging side walls of the installation grooves protruding from the inner surface of the back shell. Alternatively, the installation grooves may be arranged in such a way that the third magnet or the fourth magnet is clamped in an interference manner. In other words, the openings of the installation grooves are slightly smaller than the profiles of the third magnet and the fourth magnet, which enables the third magnet or the fourth magnet to be directly clamped into the installation grooves.

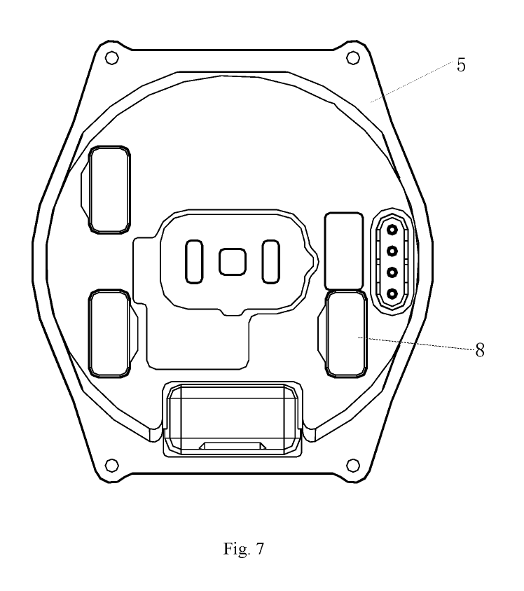

As shown in FIGS. 7 and 8, in the specific implementation, the wearable device of the present disclosure further includes one or more magnetic flux concentrating covers 8. The number of the magnetic flux concentrating covers 8 equals to the sum of the number of the third magnet 61 and the fourth magnet 62. The magnetic flux concentrating covers 8 are respectively arranged on a surface of the S pole of the third magnet 61 and a surface of the N pole of the fourth magnet 62.

Specifically, the shape of the magnetic flux concentrating cover 8 may be the same as the shape of the surface of the S pole of the third magnet. Each magnetic flux concentrating cover 8 arranged on the surface of the S pole of the third magnet may be a plate or a cap and may be attached to the surface of the S pole of the third magnet using adhesive. Similarly, each magnetic flux concentrating cover 8 arranged on the surface of the N pole of the fourth magnet may be attached using adhesive.

In the specific implementation, the second fool-proof structure further includes a bulge structure and/or a groove structure. The bulge structure is arranged on the outer surface of the back shell and is used to match with the locating groove of the charger. The groove structure is arranged on the outer surface of the back shell and is used to match with the locating bulge of the charger.

Specifically, the bulge structure may have any shape, such as a cuboid, a cube, a semi-sphere or a shape of bulging pattern. The bulge structure may be arranged at any position on the outer surface of the back shell. For example, the bulge structure may be arranged at the side edge of the back shell or on the outer surface of the back shell. When the wearable device is a smartwatch, the bulge structure may be either a bulge at the proximity of a button at the side edge of the smartwatch or a bulge at the crown. The groove structure may also have any shape, such as a cuboid, a cube, a semi-sphere or a shape of bulging pattern. The groove structure may be arranged at the side edge of the back shell or on the outer surface of the outer shell. When the wearable device is a smartwatch, the groove structure may be either a concave line on the outer surface of the back shell of the watch head or a groove arranged on the side surface of the smartwatch for receiving the button.

The above description is merely preferred embodiments of the present disclosure and not to limit the present disclosure. For those skilled in the art, all of the modifications, equivalents and improvements made to the above embodiments based on the essence of the present disclosure are intended to fall within the scope of the present disclosure.

We claim:

1. A charger, comprising:
a base, which has a holding groove, the holding groove is adapted to a back shell of a wearable device, a Pogo pin connector is arranged in the holding groove; and
a first fool-proof structure, which comprises a first insert and a second insert, the first insert and the second insert are arranged at an edge of the holding groove, the first insert has a width less than that of the second insert, the first insert is used to match with a first locating structure at a side edge of the wearable device.

2. The charger according to claim 1, wherein the first insert and the second insert are oppositely arranged at two sides at the edge of the holding groove.

3. The charger according to claim 1, wherein the first fool-proof structure further comprises:
at least one first magnet, which is arranged in the base, the first magnet has an S pole, which is directed towards an outer surface of the holding groove and is used to engage with a third magnet on the back shell; and
at least one second magnet, which is arrange in the base, the second magnet has an N pole, which is directed towards the outer surface of the holding groove and is used to engage with a fourth magnet on the back shell.

4. The charger according to claim 3, wherein the at least one first magnet comprises a plurality of first magnets, the first magnets are evenly arranged at a plurality of positions in the base corresponding to the holding groove.

5. The charger according to claim 3, wherein the at least one second magnet comprises a plurality of second magnets, the second magnets are evenly arranged at a plurality of positions in the base corresponding to the holding groove.

6. An electronic device, comprising:
a charger, which comprises:
a base, which has a holding groove, the holding groove is adapted to a back shell of a wearable device, a Pogo pin connector is arranged in the holding groove; and
a first fool-proof structure, which comprises a first insert and a second insert, the first insert and the second insert are arranged at an edge of the holding groove, the first insert has a width less than that of the second insert, the first insert is used to match with a first locating structure at a side edge of the wearable device; and
a wearable device, which comprises a first locating structure, the first locating structure is arranged at a side edge of the wearable device and matches with the first insert of the charger.

7. The electronic device according to claim 6, wherein the first locating structure is an interspace between two function buttons at the side edge of the wearable device.

8. The electronic device according to claim 6, wherein the wearable device further comprises a second fool-proof structure, the second fool-proof structure comprises:
at least one third magnet, which is arranged on an inner surface of the back shell of the wearable device, the third magnet has an N pole, which faces the inner surface of the back shell and is used to engage with the first magnet of the charger; and
at least one fourth magnet, which is arranged on the inner surface of the back shell of the wearable device, the fourth magnet has an S pole, which faces the inner surface of the back shell and is used to engage with the second magnet of the charger.

9. The electronic device according to claim 8, wherein
the at least one third magnet comprises a plurality of third magnets, the third magnets are evenly arranged on the inner surface of the back shell; and/or
the at least one fourth magnet comprises a plurality of fourth magnets, the fourth magnets are evenly arranged on the inner surface of the back shell

10. The electronic device according to claim 8, wherein the wearable device further comprises at least one magnetic flux concentrating cover, a number of the at least one magnetic flux concentrating cover equals to a sum of a number of the at least one third magnet and a number of the at least one fourth magnet,
the at least one magnetic flux concentrating cover is respectively arranged on a surface of an S pole of the third magnet and a surface of an N pole of the fourth magnet.

11. The electronic device according to claim 6, wherein the first insert and the second insert are oppositely arranged at two sides at the edge of the holding groove.

12. The electronic device according to claim 6, wherein the first fool-proof structure further comprises:
at least one first magnet, which is arranged in the base, the first magnet has an S pole, which is directed towards an outer surface of the holding groove and is used to engage with a third magnet on the back shell; and
at least one second magnet, which is arrange in the base, the second magnet has an N pole, which is directed towards the outer surface of the holding groove and is used to engage with a fourth magnet on the back shell.

13. The electronic device according to claim 12, wherein the at least one first magnet comprises a plurality of first magnets, the first magnets are evenly arranged at a plurality of positions in the base corresponding to the holding groove.

14. The electronic device according to claim 12, wherein the at least one second magnet comprises a plurality of second magnets, the second magnets are evenly arranged at a plurality of positions in the base corresponding to the holding groove.
